(19) United States
(12) Patent Application Publication
(10) Pub. No.: US 2013/0113872 A1
(43) Pub. Date: May 9, 2013

(54) VIDEO CONFERENCE SYSTEM

(71) Applicants: Chin-Yuan TING, Kuei Shan Hsiang (TW); I-Chung CHIEN, Kuei Shan Hsiang (TW); Yu-Hsing LIN, Kuei Shan Hsiang (TW); Yu-Shan HSU, Kuei Shan Hsiang (TW); Ching-Yu WANG, Kuei Shan Hsiang (TW)

(72) Inventors: Chin-Yuan TING, Kuei Shan Hsiang (TW); I-Chung CHIEN, Kuei Shan Hsiang (TW); Yu-Hsing LIN, Kuei Shan Hsiang (TW); Yu-Shan HSU, Kuei Shan Hsiang (TW); Ching-Yu WANG, Kuei Shan Hsiang (TW)

(73) Assignee: QUANTA COMPUTER INC., Kuei Shan Hsiang (TW)

(21) Appl. No.: 13/542,631

(22) Filed: Jul. 5, 2012

(30) Foreign Application Priority Data
Nov. 4, 2011 (TW) 100140245

(51) Int. Cl. H04N 7/15

(52) U.S. Cl. 348/14.07; 348/E07.083

(57) ABSTRACT

An embodiment provides a video conference system including an audio processing unit, a video processing unit and a network processing unit. The audio processing unit encodes an audio signal to an audio stream. The video processing unit encodes a pause image to a first video stream when the video conference system is in a pause mode, and encodes a video signal to a second video stream when the video conference system is in a conference mode. The network processing unit encodes the first video stream to a first network package in the pause mode, and encodes the second video stream and the audio stream to a second network package in the conference mode.

### CROSS REFERENCE TO RELATED APPLICATIONS

This application claims priority of Taiwan Patent Application No. 100140245, filed on Nov. 4, 2011, the entirety of which is incorporated by reference herein.

### BACKGROUND OF THE INVENTION

1. Field of the Invention

The present invention relates to video conferencing, and in particular relates to a video conference system and method with a pause mode.

2. Description of the Related Art

In recent years, video conferencing has become an important way to communicate between two remote users due to the development of network technologies and video compression technologies. In addition, the coverage area of wired and wireless networks have become very wide, and thus video communications using the internet protocol (IP) network is widely used. Although video conference services are provided by 3G cellular networks (e.g. the video phone protocol 3G-324M using the communications network), the popularity thereof is mute as the coverage area is limited and communications fees for services are very expensive. Thus, video conferencing using the 3G cellular network is not popular. Generally, it is necessary for a user to own a dedicated video conference system for convenience to conduct video conferencing with other users. However, sounds and images of users will always be displayed on the other device after the video conference system is enabled, which may cause inconvenience for users in some conditions.

### BRIEF SUMMARY OF THE INVENTION

A detailed description is given in the following embodiments with reference to the accompanying drawings.

An exemplary embodiment provides a video conference system. The video conference system includes an audio processing unit, a video processing unit and a network processing unit. The audio processing unit is configured to encode an audio signal to an audio stream, wherein the audio signal is captured by a sound receiver. The video processing unit is configured to encode a pause image to a first video stream when the video conference system is in a pause mode, and encode a video signal which is captured by a multimedia capturing unit to a second video stream when the video conference system is in a conference mode. The network processing unit is configured to encode the first video stream to a first network package or encode the second video stream and the audio stream to a second network package, and send the first and second network packages to a network, wherein the network processing unit encodes the first video stream to the first network package when the video conference system is in the pause mode, and encodes the second video stream and the audio stream to the second network package when the video conference system is in the conference mode.

Another exemplary embodiment provides a video conference method which is applied in a video conference system, wherein the video conference system includes a pause mode and a conference mode. First, the video conference method includes determining whether the pause mode has been triggered. When the pause mode has been triggered, a pause image which is pre-saved is retrieved. Next, the pause image is encoded to a first video stream, and the first video stream is encoded to a first network package. Finally, the first network package is sent to a network.

### BRIEF DESCRIPTION OF THE DRAWINGS

The present invention can be more fully understood by reading the subsequent detailed description and examples with references made to the accompanying drawings, wherein:

FIG. 1 illustrates a block diagram of the video conference system according to an embodiment of the invention;

FIG. 2 illustrates a block diagram of the DECT telephone according to an embodiment of the invention; and

FIG. 3 illustrates a flow chart of the video conference method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

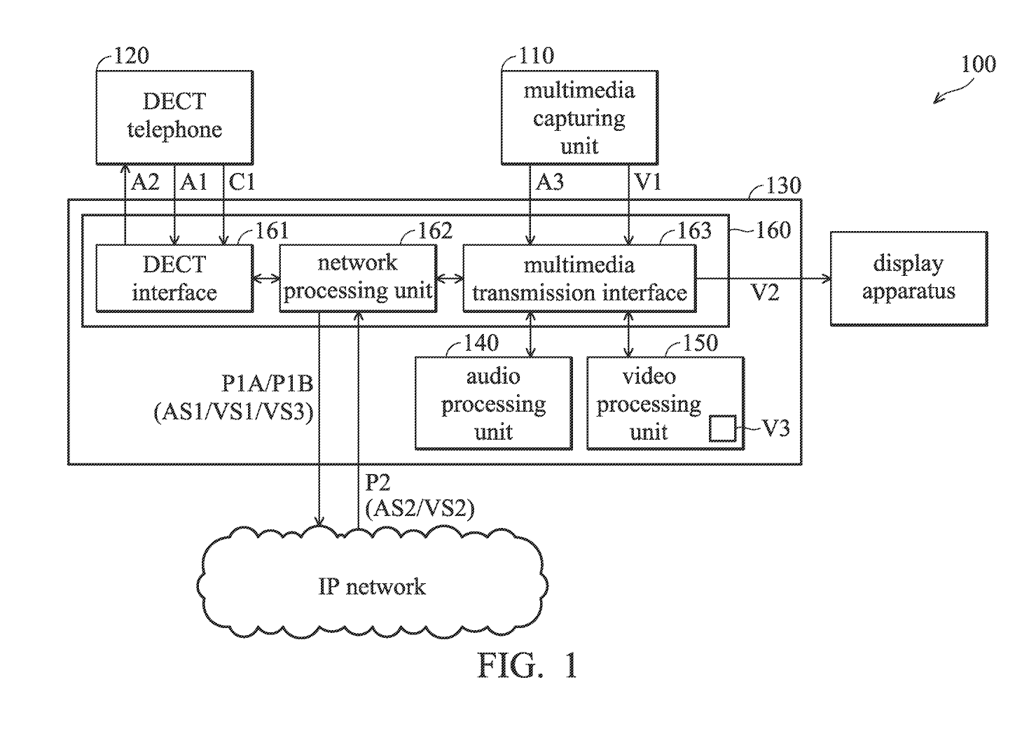

FIG. 1 illustrates a block diagram of the video conference system according to an embodiment of the invention. The video conference system 100 has two operating modes which are a conference mode and pause mode, respectively. The video conference system 100 can be operated in the conference mode when users want to activate the ordinary video conference. Additionally, the video conference system 100 can be operated in the pause mode when users do not want to be seen or heard by others.

The video conference system 100 may comprise a multimedia capturing unit 110, a digital enhanced cordless telecommunications telephone (DECT telephone hereafter) 120, and a video conference terminal apparatus 130. The video conference terminal apparatus 130 is configured to connect with another video conference terminal apparatus to exchange video signals and audio signals though an IP network (e.g. local network (LAN)), and a radio telecommunications network, and the details will be described in the following sections. The multimedia capturing unit 110 can be a light-sensitive component (e.g. a CCD or CMOS sensor), configured to receive the images of a user and output a video signal V1 according to the images. The DECT telephone 120 is configured to receive the audio signal from a remote user through the video conference terminal apparatus 130, and play the audio signal. The multimedia capturing unit 110 may further comprise a microphone (not shown in FIG. 1), configured to receive sounds from the user, and transmit the audio signal A3 to the video conference terminal apparatus 130, accordingly. The DECT telephone 120 is configured to receive sounds from the user, transmit an audio signal A1 to the video conference terminal apparatus 130, accordingly, and generate a control signal C1 to control the video conference terminal apparatus 130, and the details thereof will be described later. It should be noted that both of the DECT telephone 120 and microphone (not shown) are the sound receiver of the video conference system 100.

The video conference terminal apparatus 130, coupled to the multimedia capturing unit 110 and the DECT telephone 120, may comprise an audio processing unit 140, a video processing unit 150, and a network processing unit 160. The audio processing unit 140 is configured to receive the audio signal A1 outputted from the DECT telephone 120 through the network processing unit 160, and encode the audio signal A1 to an audio stream AS1. The video processing unit 150 is configured to receive the video signal V1 (and/or the audio signal A3) from the multimedia capturing unit 110 through the network processing unit 160 or retrieve a pre-saved pause image V3 though a bus (not shown), and encode the video signal V1 and the pause image V3 to a video stream VS1 and a video stream VS3, respectively. The pause image V3 can be pre-saved in a storage device (not shown) of the video conference terminal apparatus 130 or the multimedia capturing unit 110, but it is not limited thereto.

It should be noted that the video processing unit 150 encodes the pause image V3 to the video stream VS3 when the video conference terminal apparatus 130 is in the pause mode, wherein the video stream VS3 has a first bit rate and a first frame rate. The video processing unit 150 encodes the video signal V1 to the video stream VS1 when the video conference terminal apparatus 130 is in the conference mode, wherein the video stream VS1 has a second bit rate and a second frame rate. For example, the second bit rate can be 2 mega bits per second (2 Mbps), and the second frame rate can be 30 frames per second (30 fps). Additionally, the pause image V3 is a static picture or dynamic pictures. Therefore, the video processing unit 150 can encode the pause image V3 to the video stream VS3 with the lower bit rate and the lower frame rate for using the bandwidth efficiently. For example, the first bit rate can be 500 kilo bits per second (500 Kbps), and the first frame rate can be 5 frames per second (5 fps). The above frame rates and bit rates are one of the embodiments of the present invention, but it is not limited thereto.

The network processing unit 160 further encodes the video stream VS1 and the audio stream AS1 to a network packet NA, and communicates with another video conference terminal apparatus by network packets through an IP network for video conference. For example, the network processing unit 160 encodes the video stream VS3 which is encoded by the pause image V3 to a network packet P1B when the video conference terminal apparatus 130 is in the pause mode. The network processing unit 160 encodes the video stream VS1 which is encoded by the video signal V1 and the audio stream AS1 to a network packet P1A when the video conference terminal apparatus 130 is in the conference mode. It should be noted that the network package P1B does not include the audio stream AS1 when the video conference terminal apparatus 130 is in the pause mode in the present embodiment. In another embodiment, the network package P1B includes the audio stream AS1 when the video conference terminal apparatus 130 is in the pause mode, but it is not limited thereto.

The network processing unit 160 may comprise a digital enhanced cordless telephone interface (DECT interface hereafter) 161, a network processing unit 162, and a multimedia transmission interface 163. The DECT telephone 120 may communicate with and transmit data to the video conference terminal apparatus 130 through the DECT interface 161 with the DECT protocol. The network processing unit 162 is configured to receive the video stream VS1 or VS3 and the audio stream AS1 from the video processing unit 150 and the audio processing unit 140, respectively, and encode the video stream VS1 or VS3 and the audio stream AS1 to a network packet NA or P1B, which are further transmitted to the video conference terminal apparatuses of other users in the IP network. The network processing unit 162 is compatible with various wired/wireless communications protocols, such as the local network (LAN), the intranet, the internet, the radio telecommunications network, the public switched telephone network, Wifi, the infrared ray, and Bluetooth, etc., but the invention is not limited thereto. The network processing unit 162 may further control the real-time media sessions and coordinate the network transfer flows between each user in the video conference. The multimedia transmission interface 163 is compatible with various transmission interfaces, such as a USB and HDMI interface, for transmitting and receiving the video/audio signals.

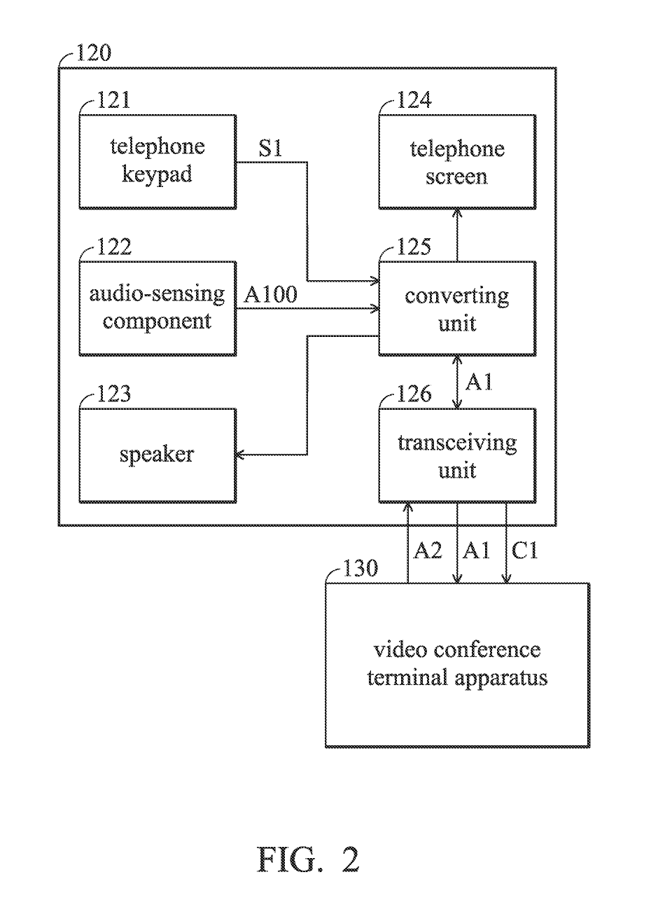

As illustrated in FIG. 2, the DECT telephone 120 may comprise a telephone keypad 121, an audio-sensing component 122, a speaker 123, a telephone screen 124, a converting unit 125, and a transceiving unit 126. The telephone keypad 121 may comprise a numeric keypad (i.e. numpad) and telephone function buttons. A user may control the DECT telephone 120 by the telephone keypad 121, and control the video conference terminal apparatus 130 by the DECT telephone 120. For example, users can trigger the pause mode by the telephone keypad 121, and the telephone keypad 121 will output a control signal C1 to the converting unit 125. It should be noted that the method of triggering the pause mode is not limited thereto. For instance, the pause mode can be triggered by the video conference terminal apparatus 130 directly in another embodiment. The audio-sensing unit 122, such as a microphone, is configured to receive sounds of the user, and output an audio signal A100. The converting unit 125 is configured to receive the audio signal A100 and the control signal S1, and convert the audio signal A100 and the control signal 51 to the audio signal A1 and the control signal C1, respectively. Then, the transceiving unit 126 may transmit the audio signal A1 and the control signal C1 to the video conference terminal apparatus 130 with the DECT protocol to communicate and transfer data. In an embodiment, the DECT telephone 120 may further receive the user interface information encoded with the DECT protocol from the video conference terminal apparatus 130 through the transceiving unit 126, and display the user interface information, which is decoded by the converting unit 125, on the telephone screen 124.

Referring to FIG. 1, the audio processing unit 140 is an audio codec (i.e. audio encoder/decoder), configured to receive the audio signal A1 from the DECT telephone 120 through the DECT interface 161, and encode the received audio signal A1 to the audio stream AS1. The audio processing unit 140 may also decode the audio stream AS1 from the other user in the video reference, transmit the audio signal A2 decoded from the audio stream AS2 to the DECT telephone 120 through the DECT interface 161, and play the audio signal A1 on the speaker 123.

The video processing unit 150 may be a video codec (i.e. video encoder/decoder), configured to receive the video signal V1 from the multimedia capturing unit 110, and encode the video signal V1 to generate a video stream VS1. The video processing unit 150 may further transmit the video stream VS1 and the audio stream AS1 to the video conference terminal apparatus of another user in the video conference through the network processing unit 162. When the network processing unit 162 receives the network packet P2 from the other user in the video conference through the IP network, the network processing unit 162 executes a process of error concealment on the network packet P2. The audio processing unit 140 and the video processing unit 150 decode the audio stream AS2 and video stream VS2 of the network packet P2, respectively, after processing the process of error concealment, and obtain the audio signal A2 and video signal V2. After obtaining the audio signal A2 and video signal V2, the display device and/or DECT telephone synchronize and display the audio signal A2 and video signal V2. It should be noted that the video processing unit 150 and the audio processing unit 140 can be implemented by hardware or software, and it is not limited thereto.

In another embodiment, the user may control the video conference terminal apparatus 130 by using the telephone keypad 121 of the DECT telephone 120, such as dialing the telephone numbers of other users in the video conference, controlling the angle of the camera, or alternating the settings of the screen. Specifically, the DECT telephone 120 may transmit the control signal to the video conference terminal apparatus 130 through the DECT interface 161 with the DECT protocol. The connection between the video conference terminal apparatus 130 and the multimedia capturing unit 110 can pass through the multimedia transmission interface 163, such as a wired interface (e.g. USB or HDMI) or a wireless interface (e.g. Wifi). The video conference terminal apparatus 130 can be connected to a display apparatus (e.g. a LCD TV) through the multimedia transmission interface 163, such as the HDMI interface or Widi (Wireless Display) interface, thereby the video screens of other users in the video conference and/or the control interface of the video conference terminal apparatus 130 can be displayed on the display apparatus, but the invention is not limited thereto.

In an embodiment, if the user A wants to conduct a video conference with the user B, the user A may use the DECT telephone 120 of the video conference terminal apparatus 130 to dial the telephone number of the video conference terminal apparatus 130 of the user B. Meanwhile, the video conference terminal apparatus 130 of the user A may receive the control message from the DECT telephone 120 through the DECT interface 161, and transmit the control message to the user B. When the video conference terminal apparatus 130 of the user B receives the phone call from the user A, the user B may respond to the phone call. Meanwhile, a video call can be built between the users A and B through the respective video conference terminal apparatus 130. The user A may use the DECT telephone 120 to receive the sounds thereof, and use the multimedia capturing unit 110 to capture the images thereof. Then, the audio processing unit 140 may receive the received sounds of the user A through the DECT interface 161, and encode the received sounds (i.e. the audio signal A1) to an audio stream AS1. The video processing unit 150 may encode the captured images of the user A (i.e. the video signal V1) to the video stream VS1. The audio stream AS1 and the video stream VS1 is transmitted to the video conference terminal apparatus 130 of the user B through the video conference terminal apparatus of the user B. On the other hand, the video conference terminal apparatus of the user B may decode the received audio stream AS1 and the video stream VS1. Then, the user B may transmit the audio signal A1 after the decoding process to the DECT telephone 120 through the DECT interface 161, thereby playing the audio signal A1. The user B may also display the video signal V1 after the decoding process on a display apparatus through the multimedia transmission interface 163 of the video conference terminal apparatus 130. It should be noted that the user B may also use the same procedure performed by the user A for exchanging video/audio signals to conduct the video conference.

In yet another embodiment, the multimedia capturing unit 110 may further comprise a microphone (not shown in FIG. 1) for receiving the sounds of the user, and outputting an output signal A3 according to the received sounds. For example, referring to the procedure of the aforementioned embodiment, the user A may use the DECT telephone 120 or the microphone of the multimedia capturing unit 110 to receive the sounds thereof. The encoding process and transmission process of the audio/video signals is the same as those of the aforementioned embodiment. Then, the video conference terminal apparatus 130 of the user B may receive the audio stream AS1 and the video stream VS1 from the user A, which are decoded to generate the audio signal A1 and the video signal V1, respectively. The video conference terminal apparatus 130 of the user B may further transmit the audio signal A1 and the video signal V1 after the decoding process to a display apparatus (e.g. a LCD TV) through the multimedia transmission interface 163 (e.g. HDMI), thereby displaying the audio signal A1 and the video signal V1. Thus, the user B may hear the sounds of the user A and view the images of the user A on the display apparatus.

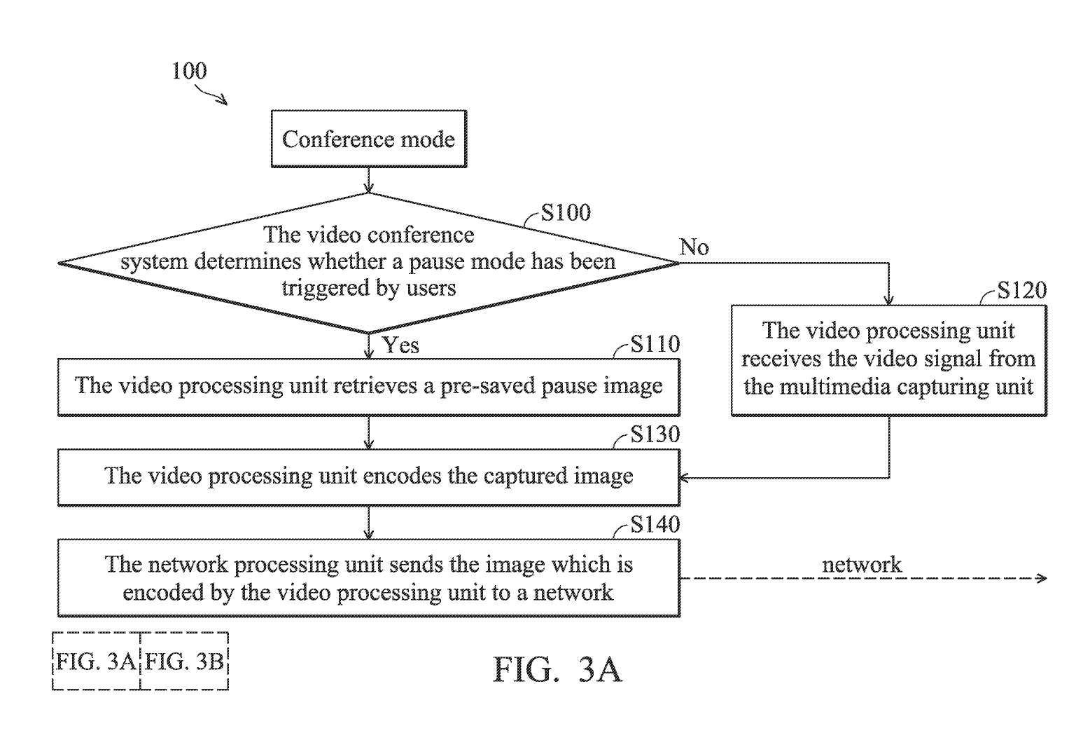

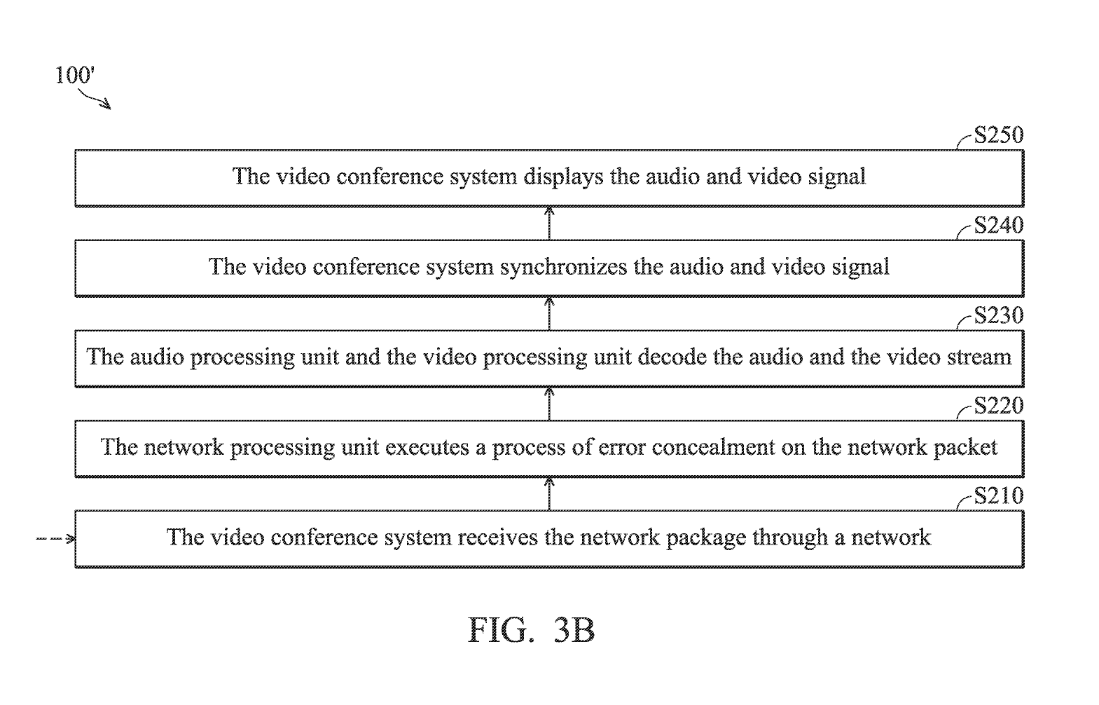

FIG. 3 illustrates a flow chart of the video conference method according to an embodiment of the invention. The process starts at the step S100 when the video conference system 100 and another video conference system 100′ are in the conference mode. It should be noted that the feature of the video conference system 100′ and 100 are the same. For the details of the video conference system 100′ and 100 reference can be made to FIG. 1.

In the step S100, the video conference system 100 determines whether a pause mode has been triggered by users. When the pause mode has been triggered by users, the process goes to step S110, otherwise, the process goes to step S120.

In the step S110, the video processing unit 150 retrieves a pre-saved pause image V3. Next, the process goes to step S130.

In the step S120, the video processing unit 150 receives the video signal V1 from the multimedia capturing unit 110. Next, the process goes to step S130.

In the step S130, the video processing unit 150 encodes the captured image. For example, the video processing unit 150 can encode the video signal V1 to a video stream VS1, or encode the pause image V3 to a video stream VS3.

Next, in the step S140, the network processing unit 160 sends the image which is encoded by the video processing unit 150 to a network. For example, during the pause mode, the network processing unit 160 encodes the video stream VS3, which is encoded by the pause image V3, to a network package P1B, and sends the network package P1B to a network. During the conference mode, the network processing unit 160 encodes the video stream VS1, which is encoded by the video signal V1, and audio stream AS1 to a network package P1A, and sends the network package P1A to a network. It should be noted that, in the pause mode, the network package P1B does not include the audio stream AS1. In another embodiment, the network package P1B includes the audio stream AS1 in the pause mode, but it is not limited thereto.

Next, in the step S210, the video conference system 100′ receives the network package P1A or P1B through a network.

Next, in the step S220, the network processing unit 162 of the video conference system 100′ executes a process of error concealment on the network packet P1A or P1B.

Next, in the step S230, the audio processing unit 140 and the video processing unit 150 of the video conference system 100′ decode the audio stream AS2 and the video stream VS2 of the network packet P1A or the video stream VS3 of the network packet P1B, respectively, after processing the process of error concealment.

Next, in the step S240, the video conference system 100′ synchronizes the audio signal A1 and video signal V1.

Next, in the step S250, the video conference system 100′ displays the audio signal A1 and video signal V1. For example, when the pause mode of the video conference system 100 has been triggered by users, the video conference system 100′ displays the pause image V3. When the pause mode of the video conference system 100 has not been triggered by users, i.e., in the conference mode, the video conference system 100′ displays the video signal V1. The process ends at the step S250.

For those skilled in the art, it should be appreciated that the aforementioned embodiments in the invention describe different ways of implementation, and the each way of implementation of the video conference system and the video conference terminal apparatus can be collocated for usage. The video conference system 100 in the invention may use the video conference terminal apparatus and a common DECT telephone with an image capturing unit to conduct a video conference with other users, thereby having convenience and cost advantages.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video conference system, comprising:
an audio processing unit configured to encode an audio signal to an audio stream, wherein the audio signal is captured by a sound receiver;
a video processing unit configured to encode a pause image to a first video stream when the video conference system is in a pause mode, and encode a video signal which is captured by a multimedia capturing unit to a second video stream when the video conference system is in a conference mode; and
a network processing unit configured to encode the first video stream to a first network package or encode the second video stream and the audio stream to a second network package, and send the first and second network packages to a network, wherein the network processing unit encodes the first video stream to the first network package when the video conference system is in the pause mode, and encodes the second video stream and the audio stream to the second network package when the video conference system is in the conference mode.

2. The video conference system as claimed in claim 1, wherein the first video stream has a first bit rate, the second video stream has a second bit rate, and the first bit rate is different from the second bit rate.

3. The video conference system as claimed in claim 2, wherein the first bit rate is lower than the second bit rate.

4. The video conference system as claimed in claim 1, wherein the first video stream has a first frame rate, the second video stream has a second frame rate, and the first frame rate is different from the second frame rate.

5. The video conference system as claimed in claim 4, wherein the first frame rate is lower than the second frame rate.

6. The video conference system as claimed in claim 1, further comprising a digital enhanced cordless telecommunications (DECT) telephone configured to capture the audio signal and trigger the pause mode.

7. A video conference method applied in a video conference system, wherein the video conference system comprises a pause mode and a conference mode, the video conference method comprising:
determining whether the pause mode has been triggered;
retrieving a pause image which is pre-saved, when the pause mode has been triggered;
encoding the pause image to a first video stream; and
encoding the first video stream to a first network package and sending the first network package to a network.

8. The video conference method as claimed in claim 7, further comprising:
capturing a video signal by a multimedia capturing unit and capturing an audio signal by a sound receiver, when the pause mode has not been triggered;
encoding the video signal to a second video stream;
encoding the audio signal to an audio stream; and
encoding the second video stream and the audio stream to a second network package and sending the second network package to the network.

9. The video conference method as claimed in claim 8, wherein the first video stream has a first bit rate, the second video stream has a second bit rate, and the first bit rate is lower than the second bit rate.

10. The video conference method as claimed in claim 8, wherein the first video stream has a first frame rate, the second video stream has a second frame rate.

11. The video conference method as claimed in claim 7, further comprising triggering the pause mode by a digital enhanced cordless telecommunications (DECT) telephone.
